(19) United States
(12) Patent Application Publication
(10) Pub. No.: US 2014/0375828 A1
(43) Pub. Date: Dec. 25, 2014

(54) APPARATUS, SYSTEMS, AND METHODS FOR CAPTURING AND DISPLAYING AN IMAGE

(71) Applicant: AmigoBooth, LLC, San Marcos, CA (US)

(72) Inventors: James Kenneth MILLER, San Marcos, CA (US); Daniel Rico CASTILLERO, San Diego, CA (US)

(21) Appl. No.: 14/218,698

(22) Filed: Mar. 18, 2014

Related U.S. Application Data
(60) Provisional application No. 61/786,448, filed on Mar. 15, 2013.

(51) Int. Cl. H04N 5/232; H04N 1/00; H04N 5/247

(52) U.S. Cl. CPC H04N 5/23206; H04N 5/247; H04N 1/00244
USPC 348/207.11

(57) ABSTRACT

The present disclosure, in its many aspects, describes devices, methods, and systems for capturing, downloading, transmitting, processing, editing and/or displaying an image, such as an image captured by a camera at a social event. In one aspect a photo booth is provided. The photo booth may include a housing, such as a housing that is configured for retaining one or more of a camera, a flash mechanism, and/or an electronic control device. The photo booth may include one or more cameras that are configured for capturing the image; may include one or more lighting features and/or flashes, such as for illuminating the field of vision that is aligned with the image to be captured; and may include an electronic control device, such as for controlling the one or more cameras and/or controlling the one or more lighting features and/or flashes. The photo booth may also include programming for carrying out these and other related operations.

### RELATED APPLICATION

This application claims the benefit of and priority to commonly owned U.S. provisional patent application Ser. No. 61/786,448, filed 15 Mar. 2013, which is herein incorporated by reference in its entirety for any and all purposes.

### FIELD OF THE DISCLOSURE

The following disclosure relates to apparatuses, systems, and methods for capturing, processing, storing, and/or displaying an image.

### BACKGROUND

Humans are social animals. So being, humans of all ages seek to connect with one another. They form groups and as a group they seek to engage with each other, as well as members of other groups, on a social level. Such engagement is facilitated by the hosting of and participation in social events. Because humans are relational they seek to memorialize and share the experiences they have at such events. One manner of memorializing such experiences involves the use of a camera to take a picture of the event and/or the persons and/or groups attending the event.

For instance, most mobile phones come standard with a camera configured to capture a digital image of the event. However, such cameras are typically not optimized for taking high-quality photos, and many of the images captured in this manner suffer from being blurry, under or over pixilated, may be grainy, and/or may be incapable of being enlarged without compromising clarity. More specifically, the number of megapixels achievable when capturing an image with a mobile phone are limited as compared to that of a stand-alone camera.

Accordingly, stand-alone cameras that are dedicated solely to taking pictures are often used at such events to capture high quality images that do not suffer from the same deficiencies, as do the pictures taken with the camera of a mobile phone. For instance, the images captured by a stand-alone camera are typically clear, crisp, vibrant, and often times can be enlarged several times its size without becoming grainy. The problem with stand alone cameras as compared to mobile phones, however, is that it requires the user to have to bring a further device to the event in addition to one's phone, which is burdensome, and unlike with a mobile phone, a user has to wait download the pictures on to their computer before they can share the images with their friends, such as by email and/or by posting them online.

Therefore, there is a need in the art for an image capturing system that allows for the capturing of high quality images that are not blurry, under or over pixilated, and/or grainy, but are clear, crisp, vibrant, and readily capable of being enlarged without sacrificing clarity; and once captured are capable of being immediately downloaded and shared at the event and/or uploaded directly to a remote database for display such as on a social media website. The devices, methods, and systems of this present disclosure aim at meeting these and other related needs.

### SUMMARY OF THE DISCLOSURE

The present disclosure, in its many aspects, describes devices, methods, and systems for capturing, downloading, transmitting, processing, editing and/or displaying an image, such as an image captured by a camera at a social event. In one aspect a photo booth is provided. In such an instance the photo booth may include a housing, such as a housing that is configured for retaining one or more of a camera, a flash mechanism, and/or an electronic control device. For instance, the photo booth may include one or more cameras that are configured for capturing the image; may further include one or more lighting features and/or flashes, such as for illuminating the field of vision that is aligned with the image to be captured; and may additionally include an electronic control device, such as for controlling the one or more cameras, with respect to their operation of capturing the image, and/or controlling the one or more lighting features and/or flashes such as with respect to their illumination of the field of vision inherent to the image to be captured.

In a basic embodiment the photo booth may simply be a stand and/or platform upon which one or more of the camera, lighting feature, flash, and/or electronic control device sits, or may simply be a sidewall within which the one or more of the camera, lighting feature, flash, and/or electronic control device resides. In various instances, the booth may include a stand and both a platform and a sidewall, wherein one or more of the camera, lighting feature, flash, and/or electronic control device may be coupled to one or both of the platform and/or the sidewall. In certain instances, the photo booth may include a plurality of sidewalls, so as to form the housing within which one or more of the camera, lighting feature, flash, and/or electronic control device are housed.

In certain particular instances, the photo booth is configured to retain one or more, e.g., all, of the cameras, lighting features, flashes, and/or electronic control devices that form the system of the disclosure, and may further be configured for housing one or more individual's whose image(s) are to be captured. For instance, in various embodiments, the photo booth may include a compartment, such as a first compartment, where the first compartment is configured for housing one or more of the cameras, lighting features, flashes, and/or electronic control devices; and in various other embodiments, the photo booth may include an additional compartment, such as a compartment that is configured for receiving one or more individuals at least partially within its bounds, so as to capture one or more images of the one or more individuals as they are positioned inside of the second compartment of the photo booth. For example, in certain embodiments, the bounds of the second compartment of the photo booth are such that the one or more individuals may be sitting or standing or both while within the booth. Accordingly, in various embodiments, the bounds of the housing may from the first and/or second compartments, such as where the bounds of the housing form the photo booth itself.

In various instances, one or more of the components of the photo booth, e.g., the camera, lighting feature, flash, and/or electronic control device may be configured for not only capturing the image, but may also be configured for downloading, transmitting, processing, editing and/or displaying the image, as described in greater detail herein below. Accordingly, in one aspect, a system for capturing, downloading, transmitting, processing, editing and/or displaying an image is provided. In various instances, the system may include one or more of a camera, configured for capturing the image; a flash, configured for illuminating a field of vision, such as a field of vision aligned with the image to be captured; an electronic control device, configured for controlling one or both of the camera and the flash; one or more other lighting features, and/or a database, configured for storing and/or processing the captured image.

For instance, in various instances, the system may include an image capturing device, such as a camera. Any suitable camera may be used, such as a stand-alone camera, or a camera associated with or otherwise coupled to a primary or secondary device, such as an electronic device. For example, a suitable camera may be one of those typically known in the art, may be a professional or consumer brand camera, may be a stand-alone camera or a camera that is associated with another electronic device, such as a mobile phone, tablet computer, computer, or the like. A suitable camera may be one that takes still shots or moving shots such as a video camera and/or recorder and/or movie camera. In certain instances, the system may include a light emitting or other illuminating device, such as a flash and/or other lighting mechanism. In various embodiments, the flash may be part of the camera itself, e.g., integral to the camera, or may be an independent device that is controlled and/or operated separately from the operation of the camera. In certain embodiments, a plurality of cameras and/or a plurality of lighting elements, such as flashes, may be included, where the cameras and/or flashes may be integral with the boundaries of the booth or included as one or more stand alone devices that are proximate to the booth, such as positioned on a stand on opposing sides of the booth or side by side. Where the illuminating device, e.g., flash mechanism, is distinct from the camera, it may be physically coupled to the booth, or may be a stand alone element, such as a flash, or other illuminating device, that is positioned proximate to the booth, such as on a stand, but electronically coupled, e.g., controlled by the system components, such as by the electronic control device.

Hence, in various embodiments, the electronic control device may be electronically coupled to the camera and/or flash mechanism so as to control the functioning thereof. For example, the electronic control device, and/or other components of the system may be physically or wirelessly coupled to one or more of each other, such as by wire or wireless communication mechanisms. More particularly, the electronic control device may be coupled to the components that it is in a master and/or servant control relationship with, such as by a wired, e.g., Universal Serial Bus (USB), connection; and/or by a wireless communication protocol, such as via infrared transmission, Wi-Fi, Bluetooth, low energy Bluetooth, and the like.

In various instances, the electronic control device may be any device capable of controlling one or more of the operations of one or more of the camera, the illuminating element, and/or one or more other system associated control devices. For instance, in various instances, a suitable electronic control device may be a remote control, a radiofrequency remote control, a persona digital assistant, smart camera, a mobile computing device, a mobile phone, a tablet computer, a laptop computer, or other computer device, such as a stand alone computer or network of computers and/or associated databases. For example, in particular embodiments, the electronic control device may be one or more of a personal digital assistant, a mobile phone, a tablet computer, a laptop computer, or other computer device that may additionally include a display screen, such as a display screen having a touch screen interface, such as where the touching of the touch screen activates, triggers, and/or otherwise controls others of the various components of the system.

In one embodiment, the electronic control device may be included as an integral part of the photo booth, such as being coupled to one or more of the platform and/or sidewalls, and in other embodiments the electronic control device may be associated with the photo booth but not integral therewith, such as where the electronic device is included on a stand that is separate from but proximate to the photo booth. In various embodiments, a plurality of electronic control devices may be included, such as where one is integral with the boundaries of the booth and/or where one is positioned on a stand that is proximate to the photo booth but not integral there with; or where both of the electronic control devices are integrally associated with the booth, such as where one is contained within a front portion of the booth and the other is contained within a back portion of the booth; or where both are independent of the booth, but one proximate a front side of the booth and one proximate a back side of the booth.

Where one or a plurality of electronic control devices are included, the one or plurality of electronic control devices may be in communication with each other and/or in communication with the other various components of the system. Furthermore, where one or plurality of electronic control devices are included, the one or more control devices may additionally include one or more displays, such as one or more touch screen displays. For instance, in one embodiment, the system may include a first electronic control device, such as where the first electronic control device includes a first computer, such as a first tablet computer having a first touch screen display, and in another embodiment, the system may further include a second electronic control device, such as where the second electronic control device includes a second computer, such as a second tablet or stand alone computer, which may or may not have a touch screen display.

For example, in various embodiments, the system may include a first and/or second and/or third and/or fourth or more electronic control devices wherein each of the electronic control devices may be a computer, a laptop computer, a tablet computer, a mobile telephone, and/or a personal digital assistant. In such an instance, the various control devices and/or associated databases may be associated in communication with one another such as by sharing a common network. Further, in various instances, one or more of the plurality of networked electronic control devices may be configured for controlling the one or more of the camera and/or lighting elements, and where the electronic control device(s) includes a display, such as a touch screen display, the touch screen display may be the element of the electronic control device(s) that is configured for one or more of triggering the camera, so as to capture the image, triggering the flash, so as to illuminate the field of vision containing the image to be captured, and/or for uploading the image to a server or other database, such as via the network and/or internet. Of course, the electronic control device may include a variety of different mechanisms that are configured for controlling the one or more cameras and/or lighting elements and/or other associated components of the booth, such as buttons, toggles, switches, keys, and the like.

In various instances, an electronic control device of the disclosure may be configured for communicating with one or more other associated electronic control devices, associated databases, associated servers, other associated components of the system, and/or one or more different user devices, such as user mobile computing devices. For instance, in certain embodiments, the electronic control device, or other components of the system, may be configured for communicating with a server. The server can either be a local server or a remote server or both a local and a remote server; and the connectivity therewith may be through a wired or wireless medium. For example, in various embodiments, the various devices and components of the system may be configured for communicating with each other and/or a local or remote server such as through a wired or wireless medium.

In one particular example, a camera and/or a lighting element, such as a flash, may be connected one to the other, or to an electronic control device, via a sync cord or wireless connection, e.g., via WiFi or Bluetooth or the like, and may further be configured to fire, e.g., substantially simultaneously or sequentially, such as whenever the control device is activated to initiate the camera to capture a photo, such as by a user touching the graphic of a button on a touch screen of the control device. Alternatively, the camera and/or flash can be connected using off-camera wireless triggering devices.

Further, in another particular embodiment, the camera and/or flash may be connected to one or more other electronic control devices, such as one or more computers, e.g., a headless computer, through a wired connection, such as via a USB cable. Of course, one or more of the camera, the flash, and/or the various electronic control devices may be connected one to the other, such as to a headless computer, or to a local or remote server, such as through a wired, Ethernet, or WiFi, or Bluetooth network connection. For instance, the one or more components of the system may communicate with one another, such as to announce that a given particular element of the system is available for connectivity with the other components of the system, such as through a wireless connection, for example, such as where the electronic control device, e.g., the triggering tablet computer, running the booth operations, looks for an associated database, such as for storing the captured images, e.g., such as contained within an associated computer, such as a headless computer, on the local network and offers to establish a wireless connection therewith. In a manner such as this, web and print services may also be effectuated over the network, such as by using Bonjour® or other suitable connectivity protocols.

In various instances, the various booth components and devices require power, which power may be supplied in any suitable manner, such as via solar power, generator, batteries, and/or electricity, e.g., via an AC, DC, AC/DC power cable. For instance, an AC power cord may be supplied to one or more of the components of the system, which power cord may be run through and/or from the booth to an outlet and/or generator and/or to any other suitable form of power supply. For example, the booth enclosure, the camera, flash, first computer, e.g., tablet computer, and second computer, e.g., headless computer, (e.g., the chargers therefore) may be connected to a power strip, such as a power strip mounted inside the enclosure, which power strip may be connected to a local power source.

As indicated above, in particular embodiments, the photo booth may include one or more electronic control devices, such as a first electronic control device, which electronic control device may be configured for controlling the operations of the booth, e.g., the camera and/or flash and/or other components of the system, for instance, where the first electronic control device is a tablet computer; and the photo booth may include a second electronic control device, such as a computer, such as a headless computer, which headless computer may be configured for interfacing with the camera, such as to receive image data therefrom, storing the same, and/or for transmitting that data to a tertiary device, such as to another data base, remote server, and/or printer. For example, a headless computer may be provided such as where the computer is configured for handling one or both of the physical, e.g., USB, or wireless connections to the camera(s), and/or the physical, e.g., USB, or wireless connection to a local or remote server and/or printer, such as a nearby photo printer.

In certain instances, the headless computer may be a control computer that does not typically provide a usable interface by a user of the booth, such as an event organizer, but rather is accessible only by the booth operator. In such an instance, the headless computer includes programming that cannot be accessible by an event organizer, but may be accessed and managed directly, such as by a booth operator, such that the booth operator can change the settings of the programming running on the headless computer. For instance, the programming of the headless computer can be configured such that the control settings can only be changed from the server application, where once made they automatically propagate to the headless computer, such as based on the booth owner's license. Accordingly, the headless computer may include programming, such as that described herein below with respect to the client application programming, which programming can be configured to send and receive various instructions and requests, such as HTTP requests, that addressed to the headless computer.

For example, the current status of the booth can be requested so as to determine whether or not one or more of the camera(s) and/or illuminating elements are connected and/or ready for operation, and whether or not there is a printer connected and whether or not it is ready for printing. Further, it can request that the camera(s) and/or illuminating device(s) may be triggered to capture an image and return the binary data for that image. Furthermore, it can request that the camera or cameras be triggered a particular number of times, or in a particular sequence or simultaneously, or one camera can be triggered sequentially a particular number of times, such as with a requested waiting period between triggers. In such a manner, a single request from the client application may be allowed, such as upon countdown for a session, rather than requiring one request for each photo taken in a session. Further still, after one or more images have been captured, one or more requests containing an image file may be sent and queued for printing, such as by a nearby printer. For instance, in one particular embodiment, the headless computer may be configured for maintaining connectivity with the server application, when possible via the Internet and when not through a wired connection, such as using a secure, reverse SSH connection. This may be useful, for example, so as to allow the software to be updated and troubleshooting potential issues may be performed remotely. Additionally, booth ownership and licensing may be tracked, such as by using data from this connection, such as in a pay per use model.

As indicated above, in particular embodiments, the photo booth may include one or more electronic control devices, such as where one or more of the control devices includes a database, and/or the system may include a separate, e.g., stand-alone, database. For instance, in certain instances, the system may include one or more databases, which one or more databases may be configured for storing and/or processing the captured image(s). The one or more databases of the system may be a separate unit from the electronic control device, e.g., the database may be a remote database, and in other instances the database may be integral to the electronic control device. In further instances, the electronic control device may include its own database, but the system may further include one or more additional databases, such as where two or more of the databases are coupled together, such as by being networked together via a wired or wireless connection.

In various instances, a database of the disclosure may included along with a central processing unit “CPU”, a memory, an editing function, a transmitter, and/or a receiver. For instance, a database may be coupled with a CPU that is configured for processing the captured image and a memory for storing the captured and/or processed image. Further, the database system may further be coupled to a receiver for receiving the captured image, such as from the camera, for example, where the database is remote from the camera; and/or the database may further be coupled with a transmitter for transmitting the captured image, such as to an additional, e.g., remote database, such as for further processing and/or editing and/or display and/or uploading such as on to the internet, e.g., prior to display.

In one aspect, programming logic for directing the operations of the system and its components is also included. For instance, in various instances, programming is provided wherein the programming is configured for controlling one or more of the operations herein described. The programming may be provided as part of the camera, the lighting element, the electronic control device, the database, and/or the server. For example, in various embodiments, the electronic control device includes programming such that upon activation of the electronic control device, a client interface may be presented to a user of the photo booth. The client interface may include information that is to be displayed to a user of the booth. The information may include any suitable material such as instructions for using the booth, descriptions of its or any of its component operations, as well as descriptions of how the booth functions to capture one or more images and/or organizes the captured images and/or associated information. The client interface may also include user inputtable data fields so as to identify the user, the event, the location, the images associated therewith, and the authorizations and/or other security feature parameters, e.g., passwords, that direct the functioning and accessing of the CPU and associated storage media.

In various instances, the client interface may present a menu of user selectable parameters. More specifically, the client interface may additionally include operational commands, such as a menu of user selectable operations that may be controlled by a user so as to effectuate the capturing of an image or a group of images, the saving and storing of the image(s), the organizing of the images (such as by event, by user, by image(s), e.g., segregated by facial recognition, and the like), the editing of the one or more images, the transmitting and/or receiving of the one or more images, as well as the downloading and/or uploading of the images. Such operations may be selectable by touching the appropriate boxes of a menu as displayed on a touchscreen display.

For example, in particular embodiments, the client interface, such as the client interface presented via an electronic control device, may be configured to direct the operation of the camera's and/or flashes capturing and/or illuminating functions. For instance, the client interface may be presented as a screen displayed by the electronic control device, such as on the touch screen of a tablet computer. In one instance, a button is presented on the touch screen such that when the button is activated, e.g., by a touch, the camera and/or flash or other lighting feature, is operated and an image is captured, e.g., digitally, and stored. The storage of the captured image may be organized by event, by location, by operator, by image, or any other suitable organizing principle.

More specifically, in various particular instances, the captured images that are stored within a particular timeframe, at a particular event, for a particular event organizer and/or authorized operators may be stored in a relational database that is governed by operational parameters that may be pre-selected by the event organizer or photo booth operator. These parameters may include instructions as to how the images are to be organized, what editable functions will be allowed, and/or who can access what stored images and/or when. Further parameters may dictate how the images may be downloaded, transmitted, uploaded, and/or displayed as well as who may purchase the images and for how much. Accordingly, the client interface may be configured for allowing one or more users to purchase the captured images, and in various instances, may include an electronic shopping cart, as known in the art, so as to allow a user to purchase one or more of the captured images, such as if all the security parameters for accessing the given event are met by the potential purchaser.

Hence, in certain instances, one or more of, e.g., all, event, photo, and/or organizer and/or user data may be stored in the relational database, which database may be governed by it's CPU's underlying business logic that functions for processing, validating, organizing, storing, and/or organizing the data, such as data originating from and organized according to the preselected client's applications that have been determined by the event organizer or booth operator, such as prior to the capturing of the image(s).

In various instances, the logic controlling the client interface may be accessible via the server application that may be intrinsic to one or more components of the system, such as to the electronic control device, such as on the server application code base, and/or may be accessible via a website interface. In various instances, the captured images, e.g., the binary photo data, may be stored locally within the database of the electronic control device, e.g., or a primary database associated locally therewith, or may be stored separately from the primary database, such as in a highly available, easily accessible, and/or redundant data store(s). In such instances, in some embodiments, the control parameters of such data stores, e.g., databases, may be managed by the logic in the server application codebase.

For instance, the client interface may itself be controlled by a server application, that functions in part to store one or more, e.g., all, of the settings for a portion or all of the various users with respect to their various associated events, and may further control the various operational permissions and settings and/or operations performable with respect to the captured and/or stored images, such as photo editing, preset information, watermarks to be applied to photos upon upload and/or download, event names, dates, event participants, organizers, and/or booth operators, locations, and the like. In particular embodiments, the server application may also function to make this data, and the associated captured and/or editable images, available to one or more users, such as locally on one of the associated databases, or remotely, such as via a website interface. In various instances, the server application can make this data available immediately, such as for immediate viewing of the captured and/or edited images by display on the users own remote devices, e.g., mobile phones and/or tablet computing devices.

Accordingly, in various particular embodiments, programming is provided for being run on one or more of the devices disclosed herein, which programming functions as an application programming interface (API), which API controls various of the operations of the system and its components. For instance, in one aspect, an API is provided, which API controls the client application's interface to the core, e.g., server-side functionality. In various instances, the API may be configured to facilitate fast and secure communication between the native applications running on the various devices of the system with respect to themselves individually and/or collectively, and may further function to facilitate fast and secure communication between the native applications running on the various devices of the system with respect to one or more, e.g., a cluster, of dedicated servers that may be running in a local or remote datacenter(s).

In one particular embodiment, a suitable API of the system may be configured to handle, e.g., control, device and/or event and/or owner and/or controller and/or user authentication so that data can be accessed securely and privately only by authorized users. In such an event, the API may be configured to permit authorized event owners and/or operators and/or controllers and/or users to manage their associated events, so as to allow them to view, create, organize, update, edit, and/or delete events and/or the captured images associated therewith. For instance, such users can password protect events and/or the captured images associated therewith, so as to prevent general public viewing in a manner such that only authorized individuals who have the event password can view the contents and/or images of the event. In certain embodiments, such users, e.g., owners of the event or images or operators of the booth, may be authorized to delete photos such as via the API. In certain instances, the API may additionally be configured to run the event store so as to accept orders for both physical and digital photos by users, which may include the capability of receiving online payments, such as via credit cards and/or PayPal®.

In various instances, when the server application receives a captured image, e.g., a photo, such as from an event, it may authorize the owner of the event, it may add the photo, and/or add the event information, and/or image data, e.g., via a facial recognition protocol, to a data-store or database, and may permanently or semi-permanently store the uploaded image, and/or may present the stored image for display upon request. The server application may also check the preselected settings for the event owner, and may apply any editing or watermark settings that were configured, so as to be present upon display of the captured image. The API may also function to resize and/or permanently or semi-permanently store several versions of the image. In various embodiments, the API may additionally function to make one or more of the stored images available for display, such as locally or on a global content delivery network (CDN). In such an instance, the API may further function to optimize the size and speed that they can be delivered back, such as to connected desktop or mobile devices, such as of a user present at the event.

Accordingly, in various instances, the server application may be configured for grouping various of the captured images, e.g., photos, into events so that various of the authorized client devices, e.g., mobile computing devices such as mobile phones or tablet computers, can view real-time images, such as streaming images, from a particular event, such as the event they are presently attending. In particular, the server application may be configured for grouping one or more, e.g., all, of the photos captured within a particular event session, into an event designated group in a manner such that the participants of that given event may be authorized to view, edit, purchase, download, upload, transmit, receive, and/or display one or more of the captured images from that event, such as immediately, e.g., while attending the event, or at a later time, such as within a limited time window, such as a limited number of days or months after the event. In a manner such as this, the photos taken with a particular group of participants at a given time and/or at a given location(s) can be grouped together for ease of viewing and/or purchasing. As indicated above, in various embodiments, the server application may additionally apply a facial recognition algorithm to one or more of the captured images in one or more of the stored events so viewers can find other photos containing one or more faces from a given group or groupings of images.

Additionally, since in various embodiments, the images captured at a given event may be grouped together by the server application, and may further be stored remotely, such as at a centralized data store or database, a plurality of photo booths may be deployed at one event, or multiple associated events that are separated geographically from one another, so that the participants thereof may employ any given booth at any given location and still be able to view and/or purchase and/or download and/or upload and/or display the images regardless of which booth at which location was employed to capture the image(s).

More particularly, since in various instances, all the captured images, are uploaded to one or more data stores and/or databases accessibly by the server application, such as during or after a particular event or a multiplicity of events, multiple photo booths can be setup at a given event or a multiplicity of events geographically separated from one another without limiting the accessibility of the captured images by the users of the different booths at the same or different events. For instance, the server application can theoretically handle an unlimited number of booths sending photos from an unlimited number of events, and all of the captured photos can be aggregated into the same event for viewing by the event participants, such as on the associated system devices and/or their own personal devices. Accordingly, in various instances, at any determined particular time during or after an event, event owners, organizers, users, and other authorized individuals may access, view, download, upload, transmit, receive, or otherwise request a partial or complete archive of one or more, e.g., all, the photos captured at the event and/or stored in one or more associated, e.g., coupled, databases and the server application may then scan, process, edit, gather, compress, and/or display the requested image(s) and/or may further store the requested image(s), such as in a zip file, that can be downloaded, such as using a link that may be transmitted, e.g., via text, SMS, email, or the like to the requestor.

In various embodiments, the programming disclosed herein, e.g., software, may be configured to run on any suitable medium, such as on iOS, Android, and other mobile platforms. In certain embodiments, the client programming may be configured so as to be the public, user-facing application that provides an intuitive interface to a user for controlling the system components. In various particular embodiments, the client programming may be configured as an application that may be made available for download to devices.

For instance, the client programming, in various embodiments, may be configured to run in one or more modes, such as a plurality of modes. For example, in a particular embodiment, the client programming may be configured to operate in two modes, such as in a view mode and/or in a trigger mode, such as as upon opening the client application, it may be configured to operate in a default mode, which default mode may be a view or trigger mode, or other mode.

Accordingly, in particular embodiments, the client programming may operate in a view mode. In such a mode, the client interface programming may use GPS location data, such as of the current electronic control device, to locate, find, and list recent and/or nearby events that may be presented to a user at the client interface, such as on a touch-sensitive display screen of the electronic control device. In such an instance, a user can touch an event on presented on the screen of the electronic control device where there may then be presented a view of the entire collection of captured images, e.g., photos, from the desired event. In various instances, an access code or password, or other authorization code, may be required to be entered into the system programming prior to allowing the selected collection of images to be viewed.

As indicated above, one or more of the captured images may be configured so as to be viewable on any suitable media, such as on a wide range of client devices, including but not herein limited to computers, web browsers, laptops, tablet computers, smartphones, personal digital assistants, other mobile computing device, and/or televisions or other forms of kiosk displays. In such an instance, such client devices may view, share, download, order, and/or print photos taken in real-time at the current event; and/or can view, share, download, order, and/or print photos taken at a past event. For instance, in certain instances, present and/or past events may be found by performing a search function by accessing an associated data store and/or database, and/or browsing to an event owner, browsing to a particular date, location, person, and/or found using arbitrary text entered into client interface presented search field.

In such an instance, once the API has been accessed, such as by a client interface presented on a display of a client device, such as via a web-portal or other wireless or wired interface, an event may be selected, any required authorization may be performed, and event photos may be viewed. For instance, in certain embodiments, event photos may be presented to a user, e.g., client, from the API through the client interface. In a manner such as this, client devices can be used to search, select, and display the various photos accessible through the API and stored in an associated data store or database. The photos to be searched and/or viewed may be presented to the client in any suitable form, and in some instances, may be configured in a pattern, such as in a grid presented via the client interface. The selection to view any given photo or sets of photos, such as presented in a grid of thumbnail photos, can be performed in any suitable manner, such as by tapping on one or more photos or boxes associated with the one or more photos, so as to display the zoomed to and/or enlarged photo.

In a manner similar to this, the user can also add one or multiple photos to a shopping cart, such as by tapping on a purchase icon, and can subsequently purchase full resolution digital copies and/or physical prints of the photos, that may be shipped to their designated address, such as via a print lab. In various embodiments, the user can also engage the client interface to engage the API so as to download and share the selected and/or purchased images from the data store and/or database. For example, in certain embodiments, a user can download or otherwise share one or multiple photos via e-mail and SMS (text), and can share one or multiple photos with various social networks (e.g., FACEBOOK®, TWITTER®, FLICKER®, INSTAGRAM®, SNAPCHAT®, and the like.). In various instances, a user can engage the client interface to print various photos, which photos can be printed to one or more nearby or remote printers located at the current event, such as from the API or other client application.

In various embodiments, the view mode may be locked, such as by an event owner or booth operator or other user, such that a viewing kiosk or photo booth, containing a display containing programming suitable for allowing one or more of the system databases to be searched and/or the images therein displayed, may then be prevented from exiting the current, e.g., pre-selected, event parameters. Hence, in such an instance, when in locked mode, a current user of the photo kiosk or photo booth may be prevented from exiting the current event, and/or may be prevented from switching to other applications on the electronic control device, and may also in a similar manner may be configured so as to ensure that any social sharing authentication data is securely deleted immediately after use.

Further, as indicated above, in particular embodiments, the client programming may also operate in a trigger mode. For instance, in a trigger mode the client application may be configured to run as a photo booth or photo-capturing kiosk. In such a mode, the booth or kiosk may be set to standby until a user activates the booth or kiosk or one or more of the components thereof. For example, in one instance, the system and/or its components may be in standby mode until a potential user enters or otherwise activates the booth or kiosk, such as, in various instances, by touching a start button, such as a start button presented on a display of an electronic control device of the system. The start button may further be engaged to activate an associated camera to trigger, and/or a lighting element to illumine, thereby capturing an image within the camera's field of view.

In another such embodiment, the system and/or one or more of its components may be on stand-by until a recognized gesture is performed by a potential user. For instance, the programming may be configured for recognizing a specific gesture, such as a hand gesture, e.g., a thumbs up, which when recognized will activate the system, e.g., the client application, to awaken and/or trigger the camera to take a picture and/or the lighting element to be illuminated. Such programming is known in the art and available such as from LEAP MOTION®. The image so captured may then be edited, such as to include various branding or advertisements, such as on a border of the captured image. Such branding and/or graphics may be set to default to text or graphics representing the booth owner or operator, or may be set to represent the event owner or organizer. The branding and/or graphic images may be in any suitable format, including any suitable text font and/or color combinations. Accordingly, in various instances, the server application can be configured so as to allow the event owner or operator to customize a portion or all text, graphics, colors, fonts, and branding displayed to users of the client application, such as where the booth or kiosk is being operated in the trigger mode. In such an instance, settings such as these may be applied on the server application, and/or may be automatically propagated to event owner and/or other user devices.

In particular instances, when a start button (such as a start button graphic, e.g., an area onscreen that emulates a button, is displayed on an electronic control device of the system) is touched, or an external physical button is pressed, or a recognized gesture is performed, or an activation countdown is otherwise triggered to begin, the client application can be activated immediately or may be activated to count down from a configurable number of seconds (e.g., 1, 2, 3, 4, 5, 10, 15, or more) to zero before taking a configurable number of simultaneous or sequential photos (e.g., 1, 2, 3, 4, 5, 10, 15, or more).

In various instances, when activated, the client application may trigger the electronic control device, such as an associated tablet computer or other computer, e.g., headless computer, connected wirelessly or via wire, e.g., USB, to the camera and/or flash in the booth or kiosk to trigger and thereby capture a photo. Once captured by the camera, the photo, or a copy of the photo, may be downloaded to the coupled electronic device, e.g. tablet or headless computer, and may further be sent, e.g. wirelessly, back to the client application, such as to a computer running the client application. The client application may further be configured to then display, e.g., a near-instant, preview of the photo, such as on a system associated display screen, thereby allowing a user in front of the camera to adjust their positions and/or facial expressions prior to the next photo or set of photos. The client application can also be configured to provide text and/or other, e.g., graphical, feedback and/or suggestions, for instance based on an analysis of the previous photos or at random, so as to suggest various changes in poses or facial expressions, such as for fun, between each photo or set of photos to be taken.

In various instances, subsequent to each photo being taken, it may be placed in a queue, such as to be uploaded synchronously or asynchronously, to the server application, such as via the application programming interface. For optimal booth operation, a wired, WiFi or cellular Internet connection may be employed. For instance, when an Internet connection is available, photos may be uploaded and processed, such as by the server application, and may be streamed back to one or more connected devices, such as in a format where the images can be sent via e-mail, shared with social networks, printed using a nearby printer, or ordered for printing, such as by a personal or professional print lab. When an Internet connection is not available, the client application can be configured to fall back to a “local” mode wherein the photos may be sent to other connected client application devices, such as where the client application devices are set for running in view mode, as described above.

Accordingly, in various aspects, a method is provided wherein the method may include configuring, such as by a server computer executing a server application, settings for one or more cameras, each of the one or more cameras being connected to the server computer via a communications network, the settings specifying camera operations in response to operation instructions received via the communications network from one or more client computers executing a client application, the camera operations including acquiring an image of a target by at least one of the one or more cameras. The method may further include receiving, by the server computer, the image of the target from at least one of the one or more cameras via the communications network, the image being associated with an event defined by the client application executed by at least one of the one or more client computers. Furthermore, the method may include storing, by the server computer, the image in a database associated with the server computer, the storing further including storing event data and user data associated with the image. Further still, the method may include transmitting, from the server computer to a requesting client computer and based on a request received from the client application executed on the requesting client computer, the image from the database to the requesting client computer, the request including at least data representing the event data and the user data.

In other aspects, a computer program may be provided. For instance, a non-transitory computer program product storing instructions that, when executed by at least one programmable processor of a server computer, cause the at least one programmable processor to perform various operations may be provided. The operations to be performed may include configuring settings for one or more cameras, each of the one or more cameras being connected to the server computer via a communications network, the settings specifying camera operations in response to operation instructions received via the communications network from one or more client computers executing a client application, the camera operations comprising acquiring an image of a target by at least one of the one or more cameras. The operations may further include receiving the image of the target from the at least one of the one or more cameras via the communications network, the image being associated with an event defined by the client application executed by at least one of the one or more client computers. Furthermore, the operations may include storing the image in a database associated with the server computer, the store further comprising storing event data and user data associated with the image. Further still, the operations may include transmitting, based on a request received from the client application executed on the requesting client computer, the image from the database to the requesting client computer, the request including at least data representing the event data and the user data.

In a further aspect, a system is provided wherein the system may include at least one programmable processor; and a machine-readable medium storing instructions that, when executed by the at least one processor, cause the at least one programmable processor to perform one or more operations. For instance, the operations to be performed may include configuring settings for one or more cameras, each of the one or more cameras being connected to the server computer via a communications network, the settings specifying camera operations in response to operation instructions received via the communications network from one or more client computers executing a client application, the camera operations including acquiring an image of a target by at least one of the one or more cameras. The operations may additionally include receiving the image of the target from the at least one of the one or more cameras via the communications network, the image being associated with an event defined by the client application executed by at least one of the one or more client computers. Furthermore the operations may include storing the image in a database associated with the server computer, the storing further including storing event data and user data associated with the image. Further still, the operations may include transmitting, based on a request received from the client application executed on the requesting client computer, the image from the database to the requesting client computer, the request including at least data representing the event data and the user data.

In an additional aspect, a computer-implemented method is provided, wherein the method may include one or more of sending, by at least one client computer executing a client application, operation instructions to at least one camera that has been configured with settings specifying camera operations in response to the operation instructions, the camera operations including acquiring an image of a target by the at least one camera, the at least one camera being connected to the server computer via a communications network, the acquiring further including acquiring event data and user data associated with the image, the image, event data and user data being stored in a database associated with the server computer. Further, the method may include sending, from the client computer to the server computer, a request for the image of the target, the image being associated with an event defined by the client application executed by the client computer, the request including at least data representing at least some of the event data or at least some of the user data. Additionally, the method may include receiving, at the client application executing on the client computer, the image from the database via the communications network, the image being received with the least some of the event data and the at least some of the user data.

Additionally, in various other aspects, a method for displaying an image is provided wherein the method includes one or more of activating a camera in a manner sufficient to capture an image, capturing the image, and/or downloading or otherwise transmitting the image, such as to a data store or database, such as a computer having a database. Where the database, or associated computer having a data store, includes a processor, the method may further include processing the image so as to produce a processed image. Further, where a transmitter and/or receiver are included, the method may additionally include transmitting and/or receiving the image, e.g., the processed image, such as to a second database. Additionally, where a display, such as a touch screen display is included, the method may include configuring the processed image and/or otherwise displaying the image.

For instance, in various embodiments, the method may include activating at least a first control device, such as a tablet or headless computer, which activation results in the activation of the one or more cameras (and/or lighting elements) so as to capture the image. For example, the activating of the first computer may further result in the activation of at least a first flash so as to illuminate a first field of vision that is aligned with the image to be captured. In certain particular embodiments, the activating may involve a user touching a screen or making a gesture to an electronic control device, which electronic control device may be a computer or may be coupled to a computer that then activates the one or more cameras, and/or one or more flashes or other lighting elements, to trigger and thereby capture the image.

Once the image has been captured, the method may include storing the digital representation of the image, such as within one or more data stores or database. Such storing may involve the transmitting of the digital representation of the image from a first to a subsequent, e.g., second, third, fourth, etc. data store or database. The transmitting may be performed by any suitable mechanism such as via physical connection, e.g., via wired connection, or may be performed through a wireless connection, e.g., by employing a wireless transmission protocol as those described herein above, e.g., infrared transmission, Wi-Fi, Bluetooth, and/or low energy Bluetooth.

Furthermore, the method may additionally include processing and/or displaying the image. For instance, the captured image may be processed, e.g., edited and/or grouped with other associated images, prior to or in conjunction with storing and/or displaying the image. In certain embodiments, the image may be transmitted to an associated device prior to display, such as where the image is transmitted to a data store or other database prior to display, such as where the image may need to be re-configured, edited, or otherwise processed prior to display. For example, in various embodiments, the captured image(s) may be transmitted to one or more users, e.g., client devices, and/or shared, e.g., via email or the internet, such as where the image is made displayable via the internet, such as when transmitted or otherwise uploaded to a social media website, such as a particular blog or FACEBOOK®, FLICKER®, INSTAGRAM®, TWITTER®, MYSPACE®, SNAPCHAT®, and the like.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is a schematic representation portraying an exemplary photo booth of the present disclosure;

FIG. 2A is a schematic representation portraying another embodiment of an exemplary photo booth of the present disclosure;

FIG. 2B is a schematic representation portraying a further embodiment of an exemplary photo booth of the present disclosure

FIG. 3A is a schematic representation portraying a rear view of the exemplary photo booth embodiment of FIG. 1 of the present disclosure;

FIG. 3B is a schematic representation portraying another rear view of the exemplary photo booth embodiment of FIG. 1 of the present disclosure;

FIG. 4 is a schematic representation portraying an additional rear view of another embodiment of an exemplary photo booth of the present disclosure;

FIG. 5 is a schematic representation of a cooling system for a photo booth of the present disclosure;

FIG. 6A is a schematic representation of the workings of a flash mechanism within an exemplary photo booth of the present disclosure;

FIG. 6B is a schematic representation of the workings of a flash mechanism within an exemplary flash pathway within a photo booth of the present disclosure;

FIG. 7A is a schematic representation of various lighting configurations that may be employed in conjunction with an exemplary photo booth of the present disclosure;

FIG. 7B is a schematic representation of another lighting configuration that may be employed in conjunction with an exemplary photo booth of the present disclosure;

FIG. 7C is a schematic representation of an additional lighting configuration that may be employed in conjunction with an exemplary photo booth of the present disclosure;

FIG. 7D is a schematic representation of various light and filter configurations that may be employed in conjunction with an exemplary photo booth of the present disclosure;

FIG. 8A is a schematic representation of an exemplary embodiment of a results screen presented at a user interface in accordance with the present disclosure;

FIG. 8B is a schematic representation of another exemplary embodiment of a results screen presented at a user interface on a handheld device in accordance with the present disclosure;

FIG. 8C is a schematic representation of an exemplary embodiment of a results screen presented at an online user interface in accordance with the present disclosure;

FIG. 9 is a schematic representation of an exemplary embodiment of a search function user interface of the present disclosure;

FIG. 10 is a schematic representation of another exemplary embodiment of an events user interface of the present disclosure;

FIG. 11 is a schematic representation of an exemplary embodiment of a particular event user interface of the present disclosure;

FIG. 12 is a schematic representation of an exemplary embodiment of a selected event user interface of the present disclosure;

FIG. 13 is a schematic representation of an exemplary embodiment of a result user interface of the present disclosure;

FIG. 14 is a schematic representation of an exemplary embodiment of a response to a result represented at a user interface of the present disclosure;

FIG. 15 is a schematic representation of an exemplary embodiment of a user selected results user interface of the present disclosure.

### DETAILED DESCRIPTION

In the following paragraphs, the present devices, methods, and systems will be described in detail by way of example with reference to the drawings. Throughout this description, the various aspects and examples shown should be considered as exemplary, rather than as limitations on the present implementations. As used herein, the “embodiment” and the “present instance” refer to any one of the embodiments of the disclosure described herein, and any equivalents. Furthermore, reference to various feature(s) of the present disclosure throughout this document does not mean that all claimed embodiments must include the referenced feature(s) as these features may be mixed or matched in any logical manifestation dependent upon the particular embodiment being employed. Furthermore, reference to the singular is understood to include reference to the plural unless the context dictates otherwise.

The present disclosure, in its many aspects, describes devices, methods, and systems for capturing, processing, storing, and/or displaying an image, such as an image captured at a social event and/or downloading and/or uploading, and/or printing the image. More particularly, devices, methods, and systems for operating one or more devices associated with capturing an image are provided along with the accompanying software applications configured for controlling the operation thereof. Accordingly, in one aspect, a booth or kiosk or podium or platform is provided wherein the structure includes a camera that is configured for capturing an image of a field of view coincident with the lens of the camera. In such instances, the systems and the components thereof herein described allow individuals and groups to take one or multiple images, e.g., self portraits, of themselves at an event and/or to immediately upload one or more, e.g., selected, images to be viewed and/or shared, such as via email or the Internet, such as via a client interface, e.g., a mobile application, that is accessible via the Internet, such as by a mobile computing device of the user. Therefore, in various aspects, software, e.g., programming, as herein described, may be provided and employed in the use and/or performance of the devices and methods herein disclosed, which software, in various instances, may be made available to a user such as for download on to a client device, e.g., a user's mobile phone or tablet computer or the like, so as to facilitate the viewing, purchasing, downloading, uploading, and/or sharing processes of the captured images. In various instances, such software may be configured for allowing a user to manage, edit, configure, customize, and/or otherwise process the images, and may further be configurable so as to manage various settings associated with the capture of said images.

Accordingly, in various particular instances, a freestanding device is provided, which device allows individuals and/or groups to capture one or a multiplicity of images, e.g., self or group portraits; and/or may further be configured for substantially simultaneously displaying and/or downloading and/or uploading the images, such as for substantially contemporaneous sharing, such as via email of the Internet, e.g., via a social media sharing platform. The hardware of the device may include one or more wired and/or wirelessly connected or networked component devices, which component devices may include one or more of, but not limited hereto: one or more professional or consumer cameras, one or more lighting elements, e.g., flashes, and one or more electronic control devices, e.g., a tablet computer and/or other computer, e.g., a headless computer. In various instances, this hardware componentry may be housed in an enclosure, such as that described with reference to the figures included herewith, which housing may be configured to house and/or hide such componentry, and its associated wires, within the bounds of the housing, such that only the operational user interface elements of the componentry may be visibly displayed. In such an instance, the housing may be configured such that only one or more display screens, e.g., tablet touch screen displays, one or more lens from one or more cameras, and/or one or more lighting elements, e.g., the light box where the flash emits its light, are displayed.

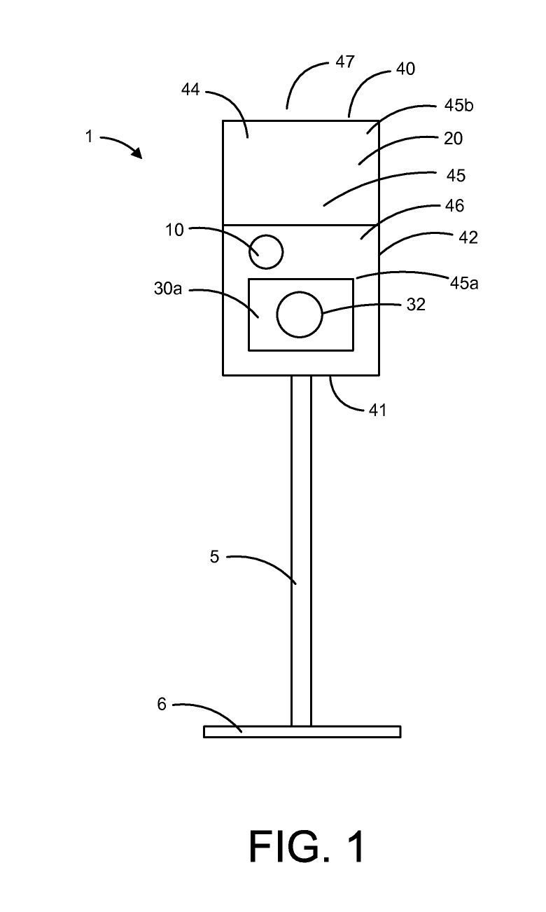

For instance, as can be seen with respect to FIG. 1, in various aspects, a system 1 for capturing an image is provided. In various instances, the system may include one or more of: one or more cameras, one or more lighting elements, and/or one or more electronic control devices. For example, as depicted in FIG. 1, a system is provided, wherein the system 1 includes at list one camera 10, at least one lighting element 20, and at least one electronic control element 30. In this embodiment, the system also includes a housing 40, which housing is configured for retaining one or more of the camera 10, the flash mechanism 20, and the electronic control device 30. In this instance, the electronic control device 30 is configured as a computer, e.g., a tablet computer, having a touch screen display 32.

The housing 40 can be any structure suitable for retaining one or more of the system components such as in a fixed and/or moveable relationship to one another. For instance, the housing 40 may include a platform 41, wherein the platform 41 may have an extended body, such as an extended body having a proximal portion, a distal portion, and opposed side portions. The housing 10 may additionally include one or more sidewalls 42, such as a sidewall 42 that may be coupled to and/or extend away from the platform 41, such as at a perimeter portion of the platform 41. The sidewalls 42 themselves may have an extended body defined by a proximal portion, a distal portion and opposed side portions. Any suitable number of side walls may be included, e.g., 1, 2, 3, 4, 5, 6, 8, 10, etc., and in various instances, at least one of the sidewalls 42 and/or platform 41 are configured for retaining one or more of the camera 10, the flash mechanism 20, and/or the electronic control device 30, in one or more orientations with respect to the housing 40.

As depicted in FIG. 1, the housing 40 is configured as a cube, having a platform 41 as well as a front sidewall 42a, opposed side portion sidewalls (not shown) and a back sidewall (also not shown), whereby in combination the platform 41 and the sidewalls 42 form the boundaries of a cube. A top member 47 may also be included. In this instance the cube forms a cavity into which the various componentry of the system may be positioned, such as the camera 10, the flash mechanism 20, and/or one or more electronic control devices 30. In various instances, the cavity may be separated into sub-cavities, such as by the addition of one or more divider elements 45 that transect the cavity and thereby dividing it into a plurality of portions.

In this instance, there is a lower cavity 45a and an upper cavity 45b, wherein the lower cavity is configured for housing the camera 10 and/or a first electronic control device 30; and the upper cavity is configured to house the illuminating element, such as flash mechanism 20. As can be seen with respect to FIG. 1, the front sidewall 42 includes one or more, e.g., a plurality, of openings configured for allowing the lens of camera 10, the touch screen display 32 of electronic control device 30a, and/or the light element of the flash mechanism 20 to be seen, while the rest of the features of the camera and the control device remains hidden, such as within the interior cavity 45a, and the rest of the flash mechanism remains hidden, such as within interior cavity 45b. Further, in this embodiment, the housing 40 may be configured as a booth, such as a cube that rests upon a stand 5, which stand 5 is secured by a base member 6.

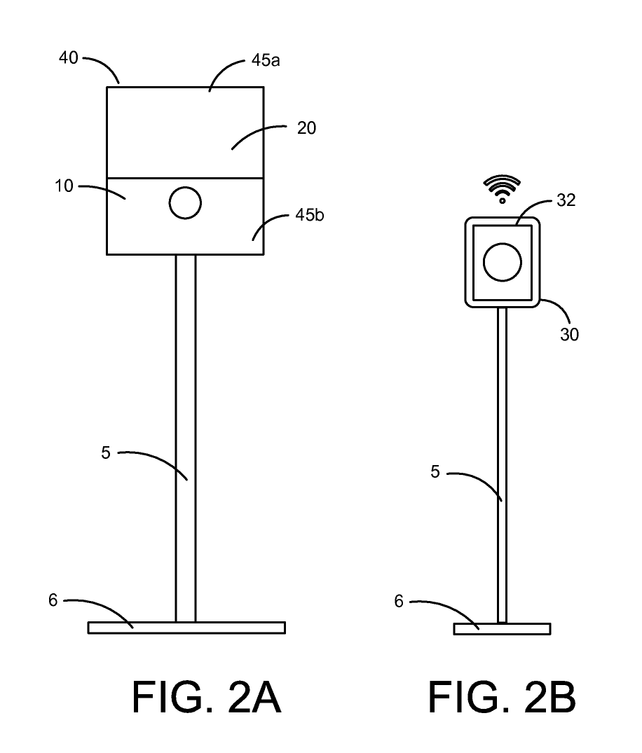

FIG. 2 illustrates a different configuration of the system of FIG. 1. In this configuration the housing 40 is configured as a booth, wherein the booth houses the camera 10 and the flash mechanism 20, but the electronic control device 30 is provided as a stand alone element that is separate from, but proximal to the booth. In this instance, the electronic control device 30 is configured as a tablet computer having a touch screen display 32, which tablet computer is configured for activating, e.g., triggering the system, such as by a user touching the “start” button graphic displayed on the touch screen 32, upon which triggering the camera 10 and/or flash element 20 will be activated so as to capture an image, such as an image of the user. Hence, in this embodiment, the electronic control device 30 is configured as a kiosk, whereby the electronic control device 30 is positioned on a stand 5, which stand is secured by base element 6.

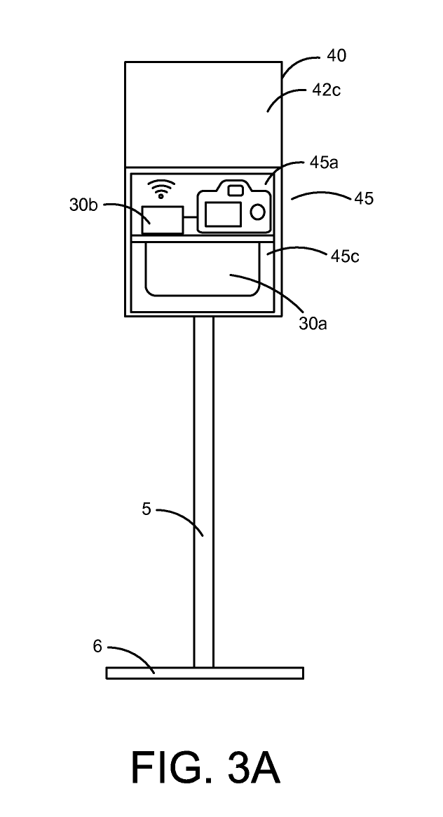

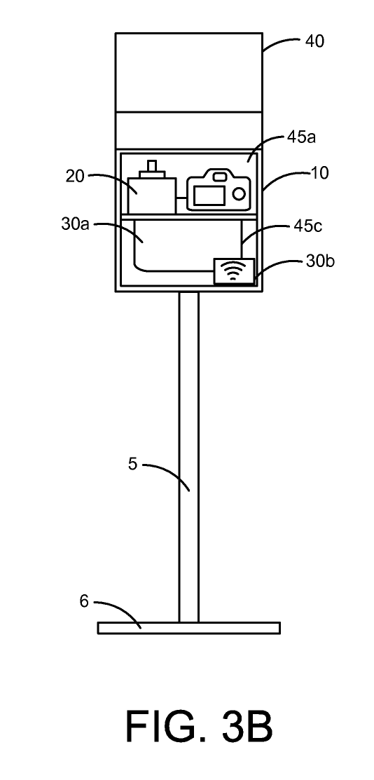

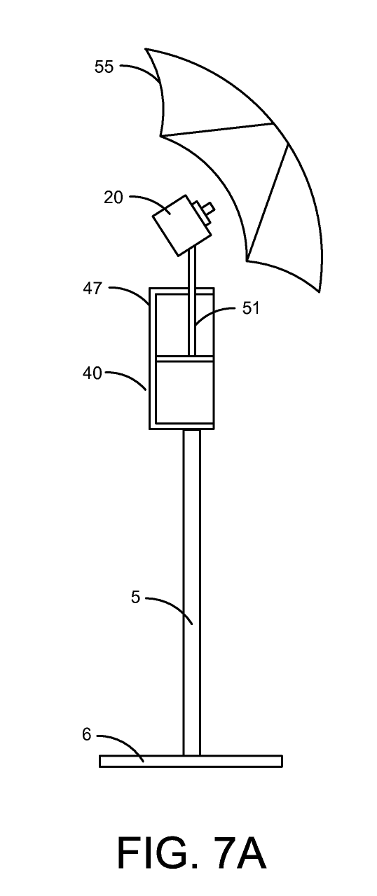

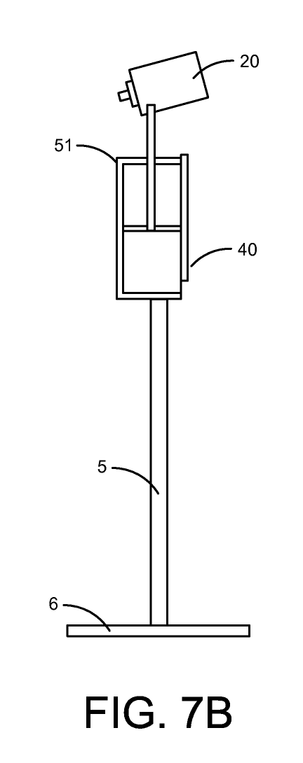

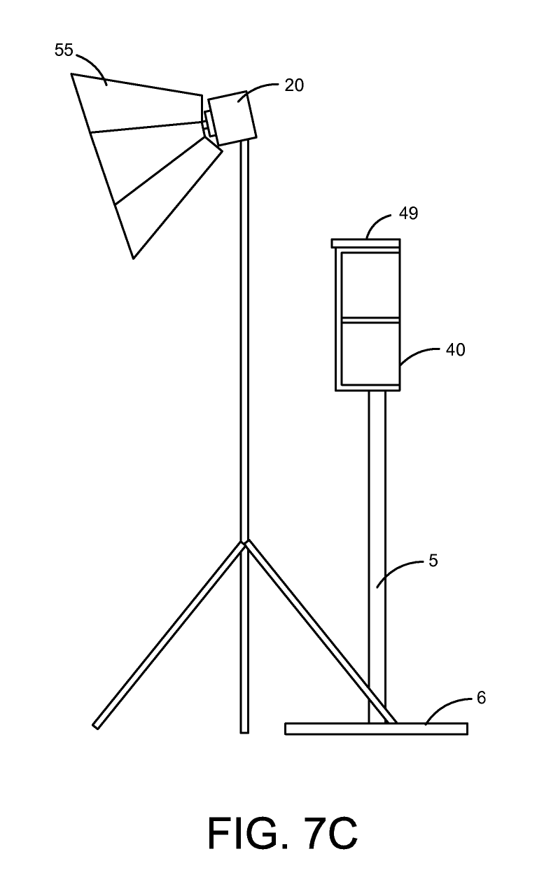

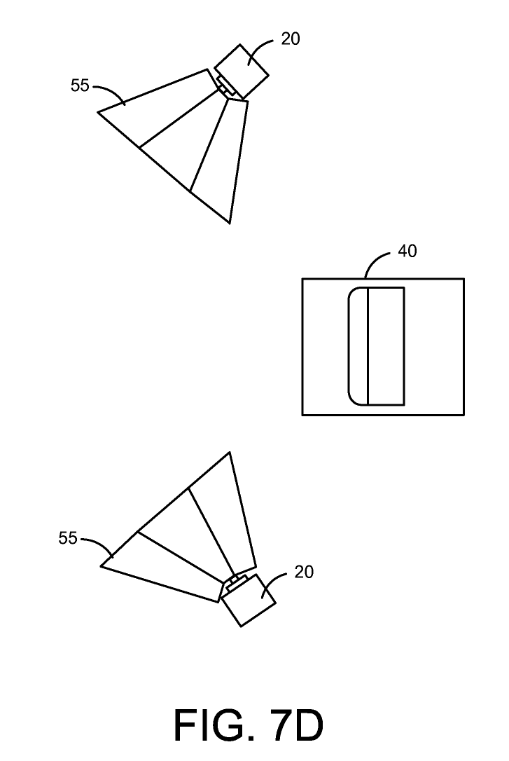

FIG. 3A represents a rear view of the booth of FIG. 1. As can be seen with respect to FIG. 3A, the housing 40 includes a moveable rear sidewall 42c, which side wall in this instance is capable of moving, e.g., sliding upwards or downwards, with respect to the housing thereby revealing the sub-cavities 45a and 45c. Compartment 45a includes the camera 10 and further includes an additional electronic control device 30b, which in this instance is configured as a headless computer. Together compartments 45a and 45c house the display screen 32 of electronic control device 30a. In this instance, the operation of the system may be triggered by activating the first electronic control device 30a, which activation may trigger the camera 10 and/or flash 20 to fire thereby capturing the image. Once captured, the image may immediately be transferred to the second electronic control device 30b for storage, such as by a wired USB connection between the camera 10 and the headless computer 30b. For instance, in various embodiments, the first electronic control device 30a, e.g., tablet computer, may be configured for loading and running the client application, which client application may function to present a user a graphic on the display 32 whereby a user can initiate the triggering of the system 1 such as by touching the graphic on the display 32. Hence, in various instances, upon touching the touch-screen 32 of the tablet computer 30a, the client application is activated, which activation may then trigger the second electronic control device 30b, e.g., headless computer, to trigger the camera 10 to take a photo. The headless computer 30b therefore may be configured for triggering the camera 10 and the camera 10 may be configured for triggering the flash 20 to illuminate as the camera takes the picture. The headless computer 30b may then further download the image file from the camera 10, and may further send the image file back to the tablet computer 30a running the client application for preview, such as can be seen with respect to FIG. 7B. In this instance, a flash 20 may or may not be included, and in various instances, the flash mechanism may be integral with, e.g., a part of the camera 10.

FIG. 3B represents a rear view of an alternative configuration the booth of FIG. 1. As can be seen with respect to FIG. 3B, the componentry of the housing 40 are arranged in a different configuration to that of the componentry of FIG. 3A. In this instance, the camera 10 and the flash 20 are housed within sub-compartment 45a, while the headless computer 30b is housed in sub-compartment 45c. Such a configuration may be desirable such as to minimize the size of the booth.

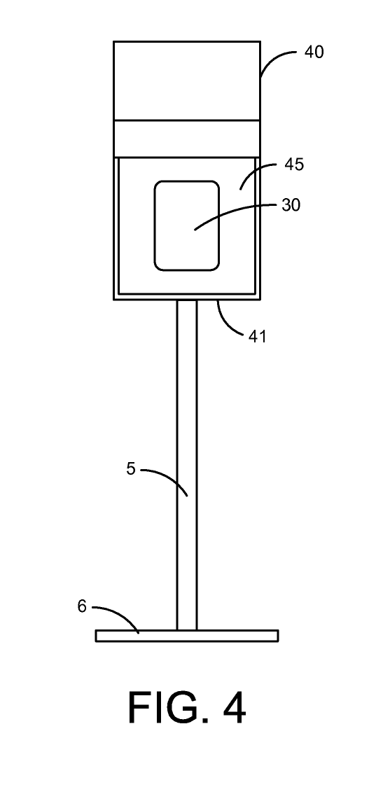

FIG. 4 represents a rear view of the display kiosk of FIG. 2. As can be seen with respect to FIG. 4A, the housing 40 includes a moveable and/or removable back panel, such that the back panel may be moved form a first, closed position, to a second open position so as to reveal the cavity 45 and the rear of the first electronic control device 30. As indicated above, the one or more sidewalls 42 and/or platform 41 may be configured for retaining the various components of the system such as the camera and the flash, and in this instance the tablet computer 30, in one or more orientations with respect to one another and/or with respect to the housing. Hence, the camera, the flash, and/or the one or more electronic control devices may be coupled to the housing in a fixed and/or a moveable orientation. In various instances, the one or more components of the system may be retained in a fixed position within the housing 40. In various instances, the one or more components of the system may be retained in a position that is configured for articulating within the housing 40.

Additionally, in various instances, one or more of the sidewalls may be configured for moving, e.g., articulating, with respect to one or more of the other sidewalls and/or the platform. For instance, a top member and/or a rear or front or other sidewall member may be configured for articulating in a wide array of angles, such as from 0 to 180 degrees in a positive or negative direction from a given centerline. In various instances, a top or side or rear member may be completely removable from the housing. In various instances, the one or more sidewalls may be coupled to each other and/or the platform in any suitable manner, such as to form the cube, such as by a coupling member selected from one or more of an adhesive, a hinge, a screw, a nail, an a hook and loop attachment agent, a string, and the like. Further, the interior of the cube may include one or more divider elements that divide the cavity into one or more, e.g., a plurality of sub-compartments, such as 2, 3, 4, 5, 6, or more sub-compartments. Additionally, it is to be noted that although the booth and/or kiosk of the disclosure is commonly referred to as a cube, the housing may be of any suitable shape and/or of any suitable size so long as it is capable of positioning the one or more system components in operational orientation with respect to one another and/or a user.

Accordingly, as can be seen with respect to FIGS. 1-4, in various embodiments, the system of the disclosure may be configured as a booth system, such as a free-standing photo booth system. In various instance, there may be 3 typical components that may be included as part of and/or within the booth. For instance, the housing of the booth 40 may form a main compartment 45 that houses the touch-screen tablet 30, a camera 10, a flash 20, and may further house the connectivity and power cords associated therewith. Additionally, as can be seen with respect to FIG. 7A, in various embodiments, a light diffuser 50 may be included and configured for being positioned on top of the main box housing 40 such as by being coupled therewith in any suitable manner, such as by being held on by magnets, such as for easy removal. A diffuser 50 may be useful so as to soften the light that comes from the flash 20 making it a better more flattering light for the user. Further, a stand 5 and base 6 may also be included to hold the main box 40 and the diffuser 50 above the ground, so as to bring the camera 10 up to eye level, In various instances, the stand 5 and/or base 6 may include a hollow channel for the power cord (and in some cases, a networking cable) to travel down while remaining unseen, such as until it hits the floor.

Hence, in various configurations, the main housing 40 may be configured to conceal the various components of the system, as described herein, in a good-looking, user-friendly enclosure. The main housing 40 may be configured such that only the parts of the components needing to be exposed, like the screen 32 of the tablet 30a and the end of the camera lens, are exposed. In such an instance, as a user approaches the front of the booth, all the user would see are the touch screen display 32 and a prompt displayed on the display prompting the user to begin a photo capturing session. In such an instance, to start a session the user need only to press the start button on the screen.

As can be seen with respect to FIGS. 3 and 4, the internal components of the booth 40 may be accessible from a back panel 42c, such as by sliding or hinging a door thereof. The flash 20 may be positioned to sit above or adjacent to the camera 10, thereby optimizing space usage inside the main housing 40. This may also be configured to shift the camera 10 so as to be off centered thereby giving the captured photos their own unique look. In other instances, the camera may be centered in the enclosure above the view screen 32. The tablet 30 may be positioned to sit all the way up towards the front panel 42a of the housing 40 allowing access of the touch screen 32 from the front facing side of the booth 40. The tablet 30 may be connected to the camera 10 inside the main housing, such as via a USB cable or wirelessly. The camera may be connected to the flash 20 either through a PC sync cord or a wireless device. In certain instances (such as when using an iOS device as the controlling tablet where hardware restrictions may prevent a physical connection), an additional microcomputer, 30b, may be used to bridge the connection between the tablet 30a and the camera 10.

In various instances, once the back panel 42c is closed and the booth 40 is ready to operate, an additional tablet 30c can be mounted to the back panel 42c, such as by using a wall mount product so that it may easily be taken on and off. This tablet 30c may be configured to act as a kiosk for users to view and share the photos they have take on the other side, such as if the system is being run in an offline mode. Alternatively, the captured images may be accessible directly via their web and/or network enabled smart phones.

For instance, in various instances, when the camera 10 is loaded in to the booth 40, it can be difficult to access the camera 10 during an event, especially if the back door 42c of the booth is dosed. In such an instance, a tablet computer 30c may be mounted to the back door 42c. This or any other electronic control device may be used to control the functioning of the camera 10, such as when a USB cable is connected to the camera 10 and/or one or more of the other electronic control devices, e.g., the tablet and/or control computer, which often times disables the physical buttons of the camera 10. This feature, therefore, allows for the ability to read and change camera settings (aperture, white balance, shutter speed, ISO, The size/egapixels, date/time, copyright, presets, format the storage card), such as by using the touch screen interface 32 of the connected tablet 30c. This feature may also add the ability to read current unchangeable settings on the camera (current battery capacity, storage (SD/CF) card capacity, camera make/model). In various instances, this communication is performed over USB such as by using the standard Picture Transfer Protocol (PTP) protocol. Such local control may also be performed by any remote device.

For example, where the tablet or control computer 30 that has the physical connection to the camera 10 maintains a connection to the Internet and maintains an open socket connection that is capable of sending and retrieving events/commands from a remote server, a remote device may be used to control the tablet 30 thereby controlling the camera 10. The remote server can send a command to the tablet 30 through this socket and ask for its current configuration, which returns a list of current configuration values. Ina manner such as this, booth owners and/or operators may remotely troubleshoot issues with camera settings, lighting issues, color issues, etc, from a website portal such as displayed on a mobile computing device.

Additionally, booth operators may employ such a method to provide recommended preset values, such as upon initial setup of a new booth or event and automatically download these settings and configure the camera and flash accordingly. It can also be used by an individual standing near the booth where they want to make changes to camera settings without interrupting the event. Physical proximity to the booth is not relevant since this remote communication may occur over the Internet. A test can be run to see what the photos look like and modifications can be made to the camera settings, then another test may be run to verify that the changes improved the quality of the photos. It can also be used to make batch updates or synchronize the settings across multiple booths all at once. It can also be used to centrally manage all booths, or booths that are owned by a given individual. Such a real-time connection provides status as to whether a booth is online/offline at a given time. It can also be used to enable or disable the availability of the booth to potential users. It can also be used to trigger a test-run without needing to be physically present. It may also be configured to allow two-way communication between a tablet and/or a control computer and/or remote servers that may not be restricted by firewall rules.

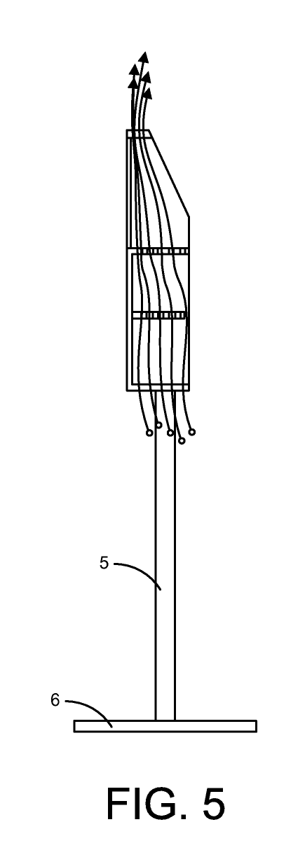

FIG. 5A represents an integrated cooling system that may be deployed in a booth and/or kiosk of the disclosure, which cooling system may or may not employ a cooling member to direct air-flow throughout the booth and/or kiosk. For instance, in various instances, the enclosure may be configured to have a natural flow of air running though it without the need for a fan. For example, in various embodiments, by placing the flash, which produces the most heat, at the top of the main housing 42b the heat produced travels upward and out of vents that may be positioned at the top of the housing. Hence, as the heat raises it pulls in fresh air through vents positioned at the bottom of the housing. This allows all the devices to stay cool while running continually. Accordingly, a cooling member may or may not be included so long as the booth is configured in a manner sufficient to adequately cool the system components and thereby reduce the chances of any one of the components overheating.

Where a cooling element is to be included, the cooling mechanism may be any suitable device capable of cooling the interior of the booth and/or kiosk and/or a component thereof. For instance, in various embodiments, the cooling mechanism incudes a fan or an electronic refrigeration device or other device capable of generating an air flow, and the housing may be configured with one or more conveyances that are designed to move the flow of air around and/or through the housing. In various embodiments, the one or more conveyances may include one or more perforations so as to facilitate the flow of air. The cooling mechanism may be battery, solar, or electrically powered.

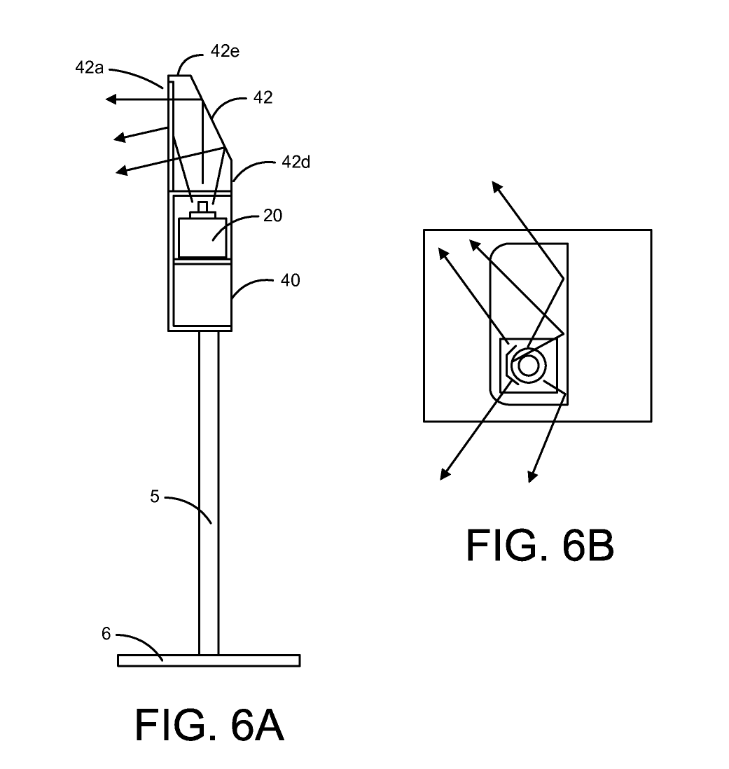

FIGS. 6A and 6B depict the light illuminating mechanism, e.g., flash element, within the booth of FIG. 3B. In this instance, the flash element 20 is orientated to direct light upwards through the booth housing 40. However, the housing 40 has been configured to accommodate this pathway by having a shape and/or an interior material layer that is designed to direct and/or angle the light outwards away from the interior of the booth and onto a field of view containing the image to be captured. Such a configuration may be useful when a softer illumination of the field of vision is desired than would otherwise occur if the flash were to directly illuminate the field of view.

Accordingly, one or more portions of one or more sidewalls that make the housing may be angled differently with respect to one another, for instance, in this embodiment, sidewalls 42a and 42d are substantially parallel to one another and top wall 42e transects sidewalls 42a and 42d substantially normal thereto. However, sidewall 42f is angled with respect to all of 42a, 42d, and 42f, which angles may be any suitable angles, such as from 1 degree to 179 degrees, so long as the resulting configuration is capable of directing the light emitted from the flash out of the booth at a desired path of travel. Further, any suitable reflective and/or refractive and/or diffusion material may be deployed such as within the bounds of the booth, such as coupled with one or more of the sidewalls thereof, so as to direct the emanation of the light, and/or to produced the desired illumination effects. As can be seen with respect to FIG. 6B, in various instances, a reflector and/or snoot may also be coupled to the booth housing to further direct and guide the travel of light.

Therefore, as can be seen with respect to FIGS. 6A and 6B, a flash diffuser may be included, wherein the flash diffuser is configured so as to allow for good, e.g., soft, light to be emitted from the booth 40 while maintaining a thinner profile and an over all pleasing physical appearance. In various embodiments, the diffuser may also be configured to allow the flash unit 20 to be run vertically instead of horizontally to minimize overall enclosure depth.

In various embodiments, the diffuser may include one or more of the following three elements. For instance, an angled back plate 42f may be included. The angled back plate 42f may be made from any suitable material and in some instances is made from a material, such as aluminum, that reflects the light forward and/or reduces the amount of light coming back on the users, such as the users waiting in line or sharing the photos from the kiosk tablet on the back. Additionally, a front diffusion material may also be included, such as where the front diffusion material may be a translucent material of a matte finish, such as a high-density polyethylene (HDPE). Such material may be flexible so that it may wrap around the curved edges of the front of the diffuser, and be configured so as to produce a soft light, such as that of an evening glow. In such an instance, the diffuser may have rounded edges so as to help bounce the light thereby helping to keep the light soft and pleasing. Further, as indicated above, a reflector and/or snoot may also be included. The reflector/snoot may be configured as a small circular piece of aluminum that fits around the actual flash bulb and causes the light from the flash to first bounce off the back plate before hitting the diffusion material. This may function to reduce the intensity of any hot spots on the diffusion material and forces a more uniform and soft light.

FIGS. 7A-7D represent various other methods of lighting and diffusion to lend to the needs and preferences of the particular booth users. For instance, the booth may include a removable top cap 47 and an extended flash pole 51, upon which a lighting element, e.g., flash, 20 is positioned, and may also include a diffuser, such as a diffuser configured as an umbrella 55, and in a manner such as this the booth 40 can accommodate a numbers of different flashes and/or diffusers. FIGS. 7A-7D show various combinations and configurations as to the various ways in which various lighting element may be used in conjunction with the booth 40. Accordingly, the systems and housings of the disclosure may be configured to accommodate various on or off-camera lighting options that can either be triggered wirelessly or through a wired cord.

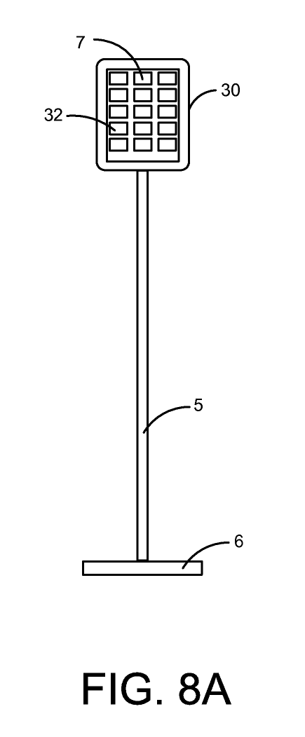

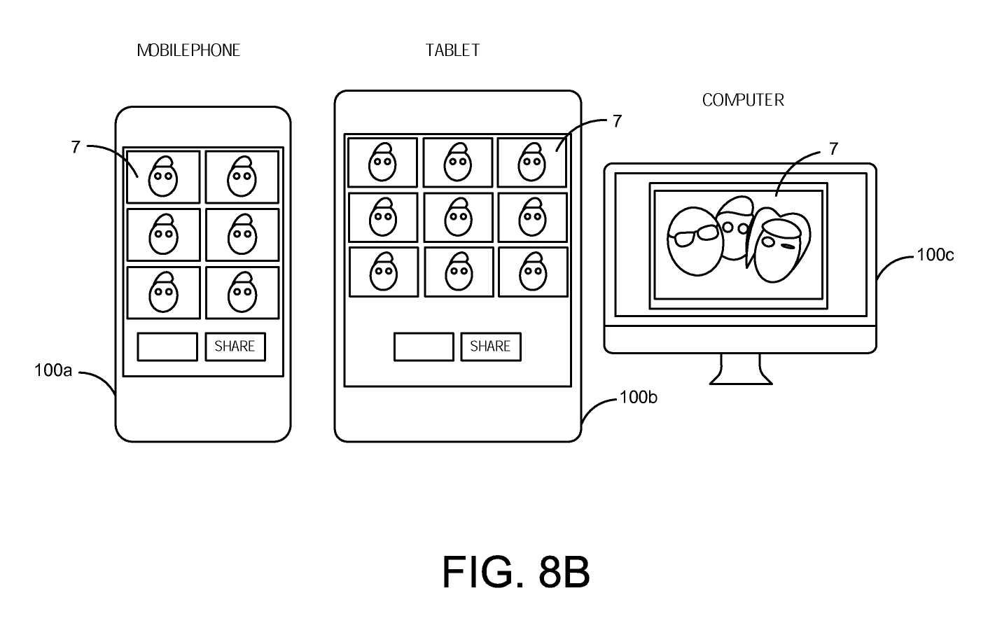

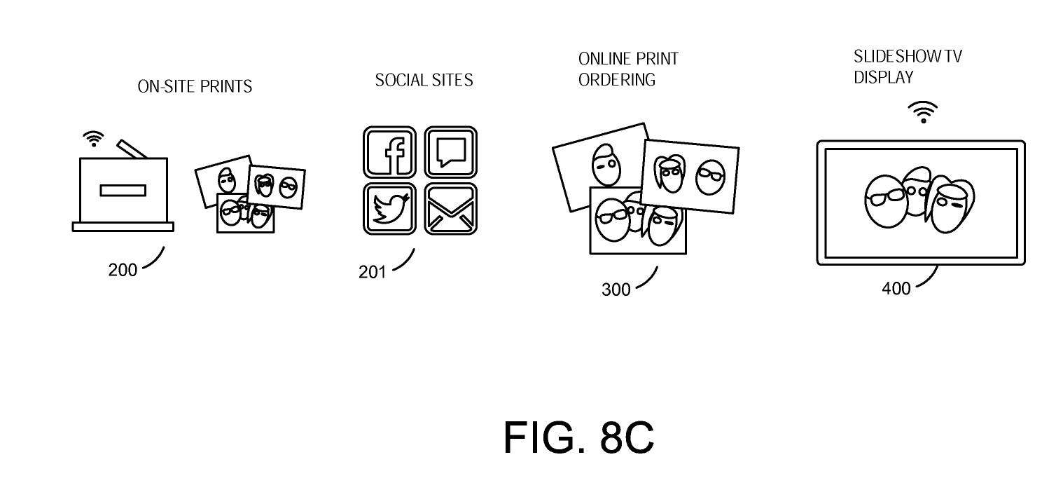

FIGS. 8A-8C illustrate an exemplary selection of the various options a user has with respect to what he or she can do with the images captured. For instance, FIG. 8A provides a kiosk 40 of the disclosure, where the kiosk includes a tablet computer 30 that is positioned on a stand 5 that is supported by a base member 6. The tablet computer 30 includes a display screen 32, which in this instance, display screen 32 is displaying an image 7. A user can view the displayed image 7 on the display screen 32 and initiate one or more functions with respect thereto. For instance, as can be seen with reference to FIG. 8B, the user can have the image 7 transmitted to an associated, e.g., networked, mobile phone 100a, a tablet computer 100b, or even to a computer monitor or TV 100c, wherein one or more of which devices may belong to the user or a local or remote third party. Additionally, as can be seen with respect to FIG. 8C, a user may also have the image 7 printed, such as on an at-site or remote printer 200; uploaded and posted on a social media network 201, such s via the web; displayed on a web enabled TV 400, and/or the user can purchase and/or order prints 300, such as via an online presented shopping forum.

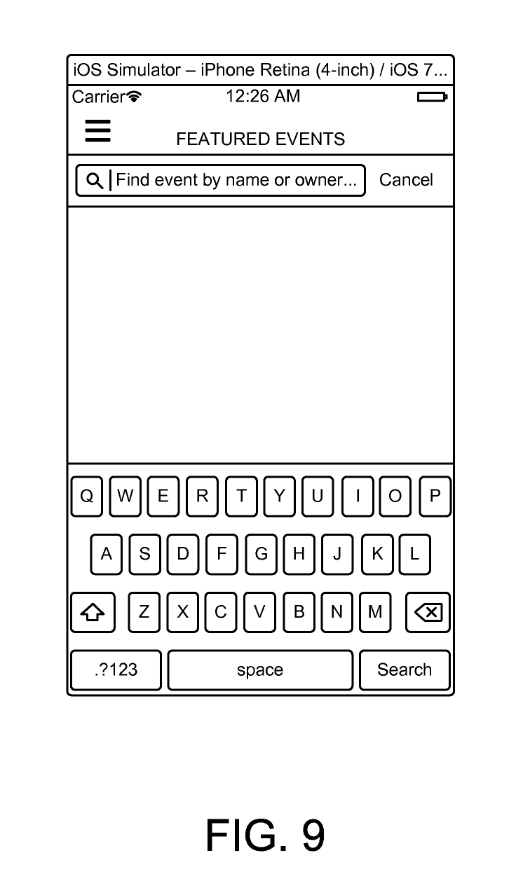

As can be seen with respect to FIGS. 9-15, after one or more photos have been captured and stored in a data store or other accessible database, in various embodiments, the data store or database may be accessed, such as via the internet, e.g., by use of a mobile computing devices, such as a mobile phone or tablet computer, searched, and various of the captured images can be selected and viewed, such as by searching through particular event characteristic parameters presented at a user interface. Accordingly, FIG. 9 presents home screen that may be the first screen that a user sees when opening the user interface application (e.g., user app). In this embodiment, what appears on the home page are “Featured Events” such as the events that the booth operator or event organizer has highlighted. In such an instance, the app may or may not prompt users to view their location. In the case that it does, the app could attempt to find events that are close to them automatically by accessing the devices geo-location functionality. In this manner a user can enter in any information that they know about the event to find the desired event. The app can search by event name, owner name, or location, and the like, so as to identify the event being sought and thereby allow the user to view groups of organized images captured at that particular event. While typing the app may be set up to filter search results simultaneously.

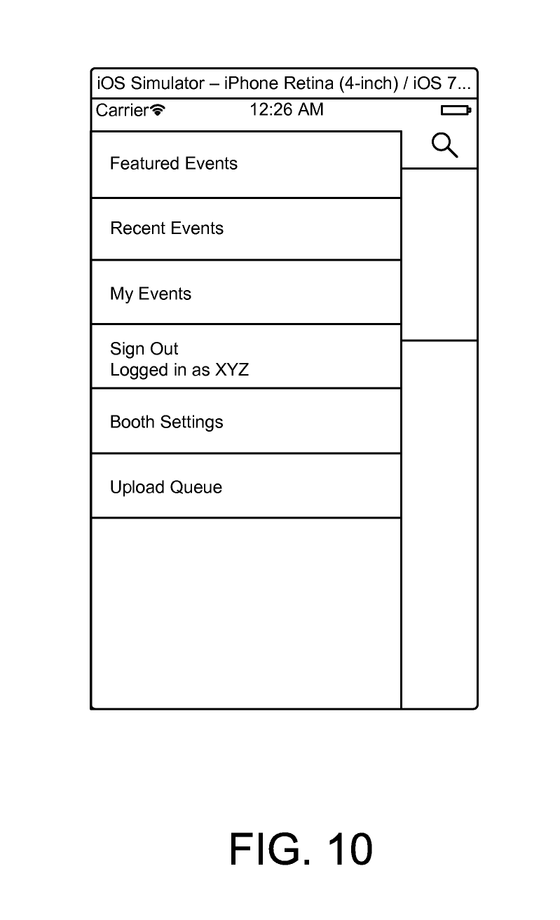

FIG. 10 presents a menu bar that in this embodiment is configured to slide out, e.g., from the left, where a user can select to view “Recent Events” (such as featured and/or not featured events) or “Featured Events” which are only the events that the booth operator decides to feature. If the user has an account with the appropriate permissions, they can login here and will then, upon authorization, they will be able to view their events, such as under a “My Events” tab. Also, a signed in user may be presented with a “Booth Settings” option and from there they may change the settings on the current session running. These settings can include but are not limited to camera aperture, shutter speed, white balance, ISO, image size, and the like. An “Upload Queue” may also be presented where the photos that did not get uploaded or failed from a session ran by the device can be viewed and retried for upload.

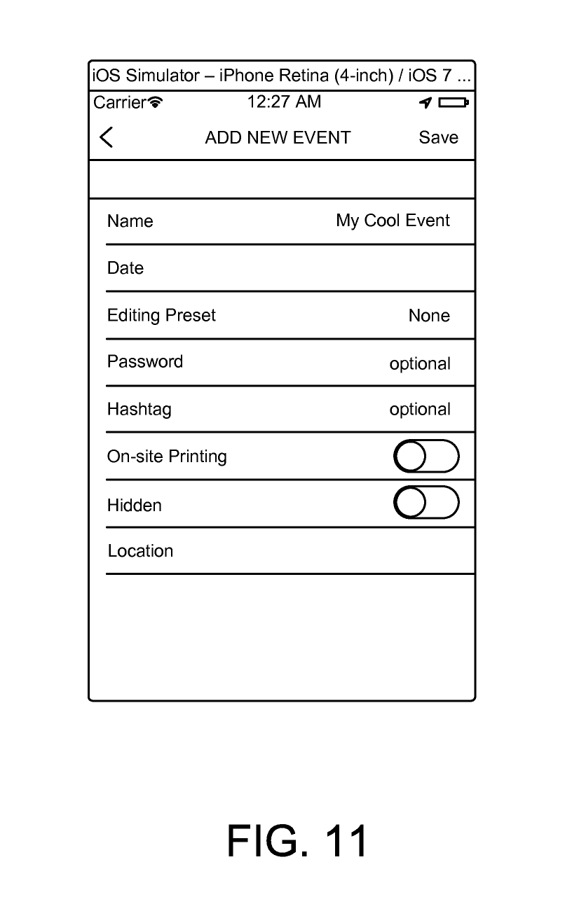

FIG. 11 presents a user interface that can also be found under “My Events,” and in this instance represents how a user can create a new event. The user can enter an event name and date. The user can also select editing presets that can be applied to a photo once the photos have been uploaded to the server, such as presets that add styling to the photos. Various preset options may include, but not limited to: black and white, enhanced color, or film look emulation, and the like. Further, if the owner of the event wants to protect the event from public view by setting a password this can be done by simply typing in a password in response to the appropriate prompt. If the owner would like a hashtag to auto fill when users share images this can be done and customized here as well. Additionally, when images are emailed the hashtag entered here can also be in the email as a reminder. The on-site printing slider enables printing on site if the owner desires and has the appropriate equipment.

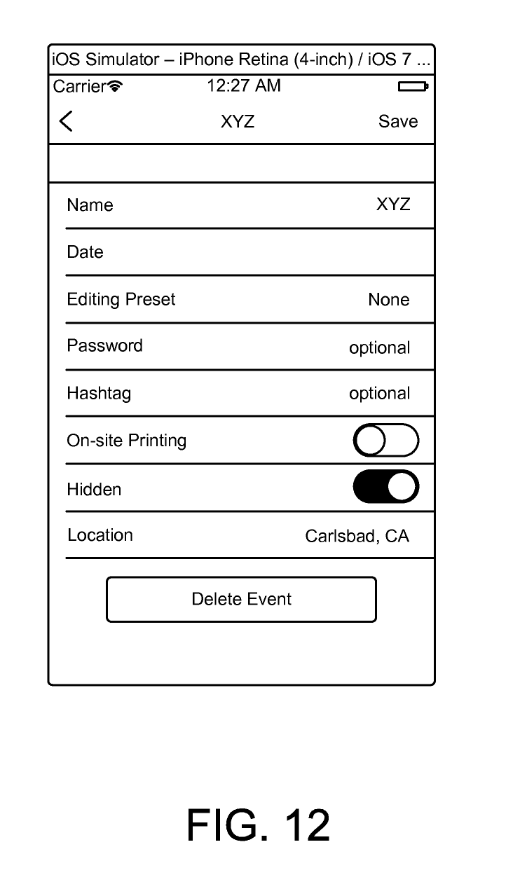

As can be seen with respect to FIG. 12, the “Hidden” slider when enabled hides the event completely from the app, so other app users would not be able to see the event in the list of recent events. In this instance, the “Hidden” slider has been turned on, thus hiding this event from the app list of recent events. When enabled and not “Hidden”, the location section, will look to find where the device is and fills in with the city and state the event that is occurring.

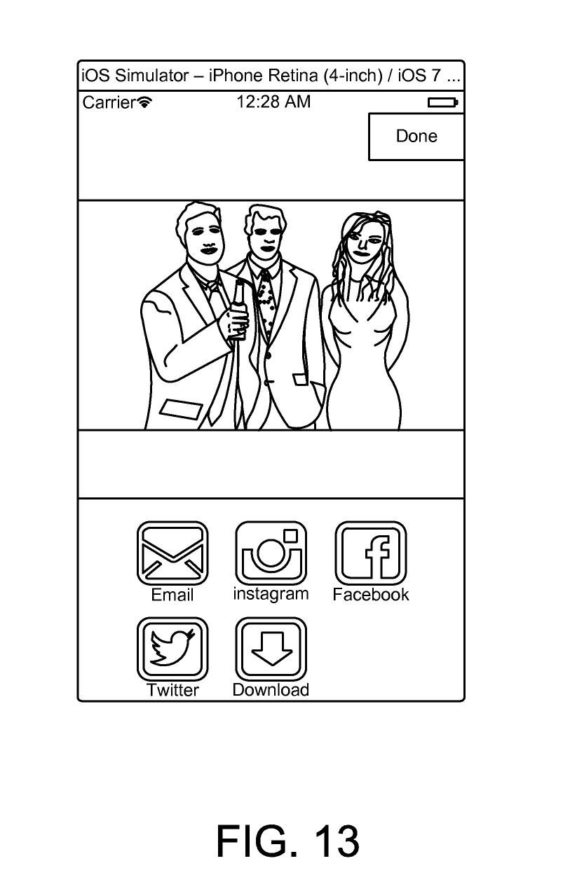

FIG. 13 presents a large view/single image view. Users can see the image larger than in a multi-image view and when used on a personal device the user may be presented with certain sharing options. Sharing options include but are not limited to emailing the photo, opening the image in a social media web interface context for posting, sharing the image on a personal website page, transmitting the image over an internet protocol, directly downloading an image to the current device, or instantly printing the image if on-site printing is enabled.

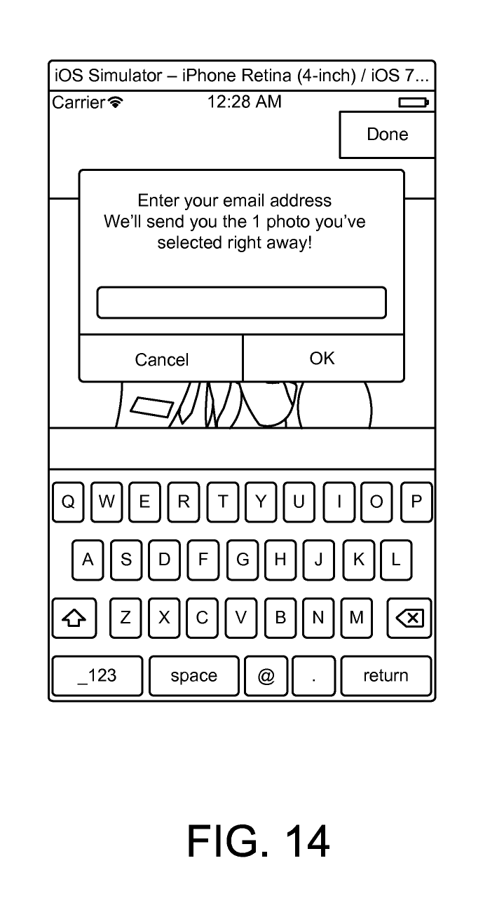

FIG. 14 presents a screen where a user can enter their email address to have the selected photo/photos emailed to them.

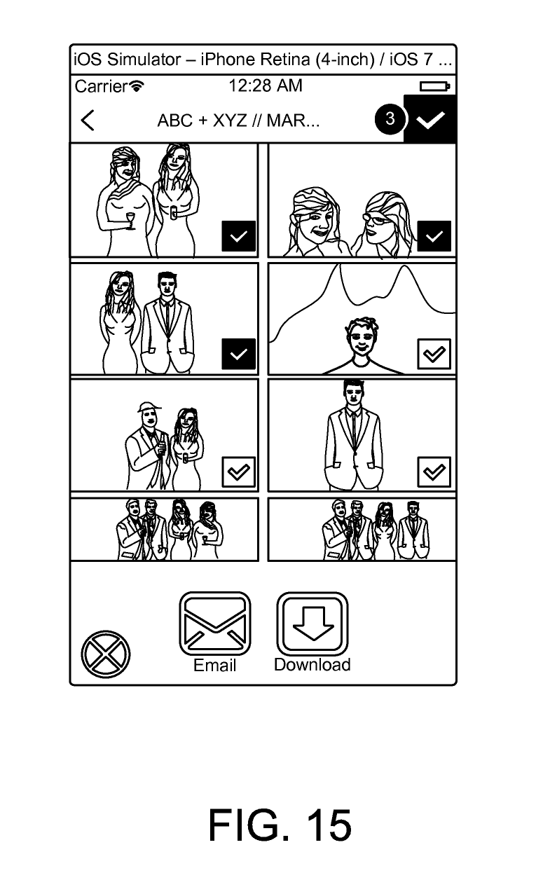

FIG. 15 is often a first screen that a user sees when entering an event. The user can see multiple photos from the current event and when new photos are taken they appear at the top and push the older photos down in the scroll. Photos usually come in within seconds of being taken. Users can also select multiple photos at once by first pressing the check symbol in the upper right hand corner. They then can select multiple images by pressing the desired images. Then the user can email the selected photos or download them directly to the device. Pressing the X button in the bottom left closes the multiple select mode and now if a user selects a photo it opens the photo in the larger single image view.

Accordingly, as set forth herein, in various aspects a system for capturing an image is provided wherein the system may include one or more of a camera configured for capturing an image; a flash, configured for illuminating a field of vision aligned with the image to be captured; and/or one or more electronic control devices that may be configured for controlling one or both of the camera, with respect to its operation of capturing the image, and the flash, with respect to illuminating said field of vision. In various instances, the electronic control device may be electronically coupled to one or more of the camera and or flash, such as by a wired or wireless connection. In various instances, the electronic control device may include a display screen, such as a touch screen and other instances, it does not. In particular embodiments, the electronic control device may be a tablet computer or a headless computer. In various instances, the electronic control device may be a tablet computer, such as a tablet computer that is configured for one or both of triggering the camera to capture the image and/or for uploading the image to a server, such as a local or remote server.

The system may also include a data store and/or a database, such as for storing the captured image(s). Such a data store and/or database may be integral to the electronic control device or remoter therefrom and/or may be part of a server or network of associated computers and/or servers. In various instances, the database may be associated with one or more of a CPU and a memory, such as a CPU that is configured for processing the captured image, and a memory that is configured for storing the captured and/or processed image. In some instances, the database may further be associated with a receiver for receiving the captured image from the camera, and/or may further be associated with, e.g., coupled to, a transmitter for transmitting the captured and/or processed image.

In certain embodiments, the system may include a plurality of data stores and/or databases such as 2, 3, 4, 5, 10, or more. For instance, in one embodiment the system may include a first data store for receiving a captured image, such as from the camera, and may further include a second database for processing, editing, storing, and/or uploading the image such as on to a server. In such an instance the second database may be configured for receiving the image from the first data store. Further, in various embodiments, one or more of the data stores and/or databases may be coupled to a display, such as a touch screen display. For instance, in one embodiment, the second database may be comprised of a second computer. In various instances, the first or second database may be coupled to a third or more databases.

Further, as set forth herein, in various aspects a method for capturing and/or displaying an image is provided wherein the method may include one or more of activating a camera in a manner sufficient to capture an image, such as by triggering a control device, such as a tablet computer that is operationally connected to the camera; capturing the image; transmitting the image to a data store; and/or may further include transmitting the image to a database, such as where the database comprises a processor; and/or may additionally include editing and/or processing the image so as to produce an edited and/or processed image; transmitting the processed image to an additional database; configuring the processed image for displaying; and/or displaying the image.

In various instances, the activating may include activating at least a first control device, such as a computer, e.g., a tablet computer, which activation of said first computer results in activating at least a first camera so as to capture the image. The activation of the camera may also include the activation of at least a first flash or other illuminating device, so as to illuminate a first field of vision aligned with the image to be captured. In one embodiment, the first computer is a tablet computer having a touch screen interface and the activation occurs by a user touching the touch screen interface. In various embodiments, after the image has been captured the image may be transmitted, e.g., in digital format, from the camera to a first database, such as via a wired or a wireless transmission, such as by one or more of an infrared transmission, Wi-Fi, Bluetooth, and low energy Bluetooth.

In various other embodiments, the method may include displaying of the image, such as at a local or remote display such as for viewing. In certain instances, the displaying may include the transmission of the image to a database configured for making the image available to display via the internet, such as by transmitting the image to an internet site including one or more of FACEBOOK®, FLICKER®, INSTAGRAM®, TWITTER®, MYSPACE®, and the like.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A method comprising:
configuring, by a server computer executing a server application, settings for one or more cameras, each of the one or more cameras being connected to the server computer via a communications network, the settings specifying camera operations in response to operation instructions received via the communications network from one or more client computers executing a client application, the camera operations comprising acquiring an image of a target by at least one of the one or more cameras;
receiving, by the server computer, the image of the target from the at least one of the one or more cameras via the communications network, the image being associated with an event defined by the client application executed by at least one of the one or more client computers;
storing, by the server computer, the image in a database associated with the server computer, the storing further comprising storing event data and user data associated with the image; and
transmitting, from the server computer to a requesting client computer and based on a request received from the client application executed on the requesting client computer, the image from the database to the requesting client computer, the request including at least data representing the event data and the user data.

2. A non-transitory computer program product storing instructions that, when executed by at least one programmable processor of a server computer, cause the at least one programmable processor to perform operations comprising:
configure settings for one or more cameras, each of the one or more cameras being connected to the server computer via a communications network, the settings specifying camera operations in response to operation instructions received via the communications network from one or more client computers executing a client application, the camera operations comprising acquiring an image of a target by at least one of the one or more cameras;
receive the image of the target from the at least one of the one or more cameras via the communications network, the image being associated with an event defined by the client application executed by at least one of the one or more client computers;
store the image in a database associated with the server computer, the store further comprising storing event data and user data associated with the image; and
transmit, based on a request received from the client application executed on the requesting client computer, the image from the database to the requesting client computer, the request including at least data representing the event data and the user data.

3. A system comprising:
at least one programmable processor; and
a machine-readable medium storing instructions that, when executed by the at least one processor, cause the at least one programmable processor to perform operations comprising:
configuring settings for one or more cameras, each of the one or more cameras being connected to the server computer via a communications network, the settings specifying camera operations in response to operation instructions received via the communications network from one or more client computers executing a client application, the camera operations comprising acquiring an image of a target by at least one of the one or more cameras;
receiving the image of the target from the at least one of the one or more cameras via the communications network, the image being associated with an event defined by the client application executed by at least one of the one or more client computers;
storing the image in a database associated with the server computer, the storing further comprising storing event data and user data associated with the image; and
transmitting, based on a request received from the client application executed on the requesting client computer, the image from the database to the requesting client computer, the request including at least data representing the event data and the user data.

4. The method according to claim 1, wherein the method is implemented by a computer, the computer implementing the following steps:
sending, by at least one client computer executing a client application, operation instructions to at least one camera that has been configured with settings specifying camera operations in response to the operation instructions, the camera operations comprising acquiring an image of a target by the at least one camera, the at least one camera being connected to the server computer via a communications network, the acquiring further comprising acquiring event data and user data associated with the image, the image, event data and user data being stored in a database associated with the server computer;
sending, from the client computer to the server computer, a request for the image of the target, the image being associated with an event defined by the client application executed by the client computer, the request including at least data representing at least some of the event data or at least some of the user data; and
receiving, at the client application executing on the client computer, the image from the database via the communications network, the image being received with the least some of the event data and the at least some of the user data.
